(19) United States
(12) Patent Application Publication
(10) Pub. No.: US 2019/0176319 A1
(43) Pub. Date: Jun. 13, 2019

(54) Multi-Purpose Equipment Stand

(71) Applicant: Angela Jane MCCALLUM, Nanaimo (CA)

(72) Inventor: Brayden Russell WILTSEY, Nanaimo, BC (CA)

(21) Appl. No.: 16/302,630

(22) PCT Filed: May 23, 2017
(86) PCT No.: PCT/CA2017/000134

§ 371 Date: Nov. 17, 2018

Related U.S. Application Data
(60) Provisional application No. 62/429,794, filed on Dec. 3, 2016.
(60) Provisional application No. 62/339,421, filed on May 20, 2016.

(51) Int. Cl. B25H 1/16; B25H 5/00; B60R 9/06; B65H 49/30; F16M 3/00; B62B 1/20; B62B 5/00

(52) U.S. Cl. CPC B25H 1/16; B25H 5/00; B60R 9/06; B65H 49/30; B62B 2205/12; B62B 1/208; B62B 5/0003; B62B 2203/071; F16M 3/00

(57) ABSTRACT

An equipment stand having a main support beam with opposing first and second ends; a rotating hub and spindle assembly attachable at its lower end to the main support beam; a first platform mounted to the upper end of the rotating hub and spindle assembly; a support leg attached perpendicularly to the first end of the main support beam; a vehicle hitch connection post extending perpendicularly from the support leg and colinearly with the main support beam; lifting means hingedly connected to the second end of the main support beam; and telescopic tubing connecting the lifting means to a wheel and axle assembly. The equipment stand may be used for storage, transport or operation of various construction trades equipment including pipe and bolt threaders, generators, coiling frames, saws, and other construction trades equipment.

### FIELD OF THE INVENTION

The present invention relates to the construction trades. In particular, the present invention relates to multi-purpose construction equipment stands.

### BACKGROUND OF THE INVENTION

Pipe and bolt threaders and similar pieces of construction equipment are large, bulky, and heavy pieces of equipment, some exceeding 300 lbs. They are regularly required to be loaded and unloaded in and out of trucks and vans by a variety of construction trades for use at different work sites. It is both time consuming and back breaking work setting up and tearing down construction equipment at work sites.

While in many cases worksites are accessible by vehicle, in some cases it is necessary to work in a location which is inaccessible to the equipment operator's vehicle.

It is desirable, therefore, to provide an equipment support stand which can remain in an assembled state for ease of use, and which may be mounted on a vehicle's hitch or used remotely from the vehicle. The multi-use equipment stand apparatus of the present invention saves a significant amount of time and effort for both setting up and taking down a pipe threader or other trades equipment while increasing flexibility of access to the work site.

### SUMMARY OF THE INVENTION

There is provided an equipment stand comprising a main support beam having opposing first and second ends; a rotating hub and spindle assembly attachable at its lower end to the main support beam; a first platform mounted to the upper end of the rotating hub and spindle assembly; a support leg attached perpendicularly to the first end of the main support beam; a vehicle hitch connection post extending perpendicularly from the support leg and colinearly with the main support beam; lifting means hingedly connected to the second end of the main support beam; and telescopic tubing connecting the lifting means to a wheel and axle assembly. The lifting means may be an adjustable jack such as an hydraulic jack.

The position of the rotating hub and spindle assembly may be adjustable along the length of the main support beam. The length of the telescopic tubing may be adjusted incrementally. The support leg may be adjustable telescopic tubing. The height of the platform, whether the stand is free standing or attached to a vehicle, may be selected by adjusting the lifting means at the rear end of the stand and the telescopic support leg at the front end of the stand.

The first platform may be fully rotatable about the axis of the rotating hub and spindle assembly. The equipment stand may have a second platform reversibly connected along edge of the first platform.

The equipment stand may have a rotatable coiling frame attached to the upper surface of the first platform and a coiling guide attached to the main support beam for use in coiling pipe or wire. The equipment stand may have a plurality of generator frame guides attached to the upper surface of the first platform for use as a generator stand.

The wheel and axle assembly may be rotated between a raised position wherein the wheels are above the support surface in proximity to the main support beam, and a lowered position wherein the wheels are in contact with the support surface.

There is also provided a portable equipment stand assembly comprising any of the equipment stand embodiments attached by a vehicle hitch to a vehicle.

The invention further comprises an equipment stand kit comprising the components described herein for assembly.

### BRIEF DESCRIPTION OF THE IMAGES

A detailed description of the preferred embodiment is provided by way of example only and with reference to the following images, in which:

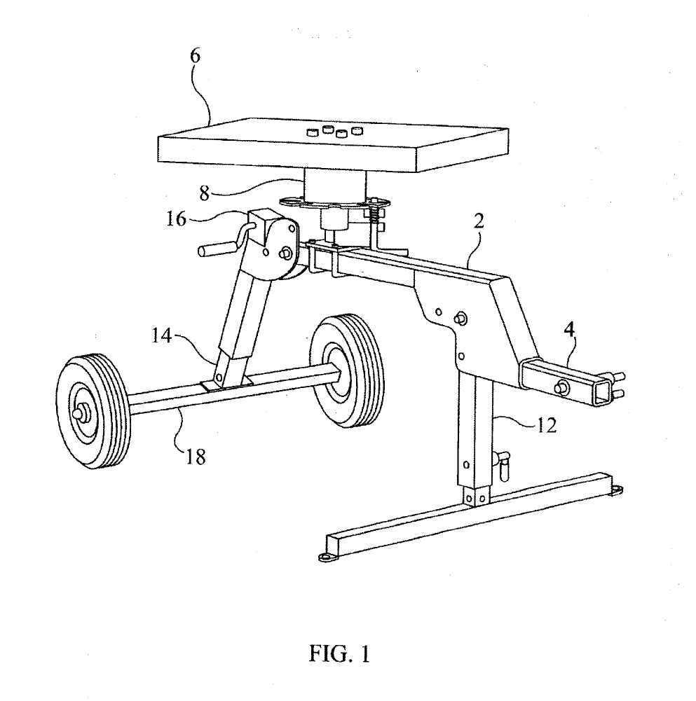

FIG. 1 is a perspective view of one embodiment of the equipment stand of the invention;

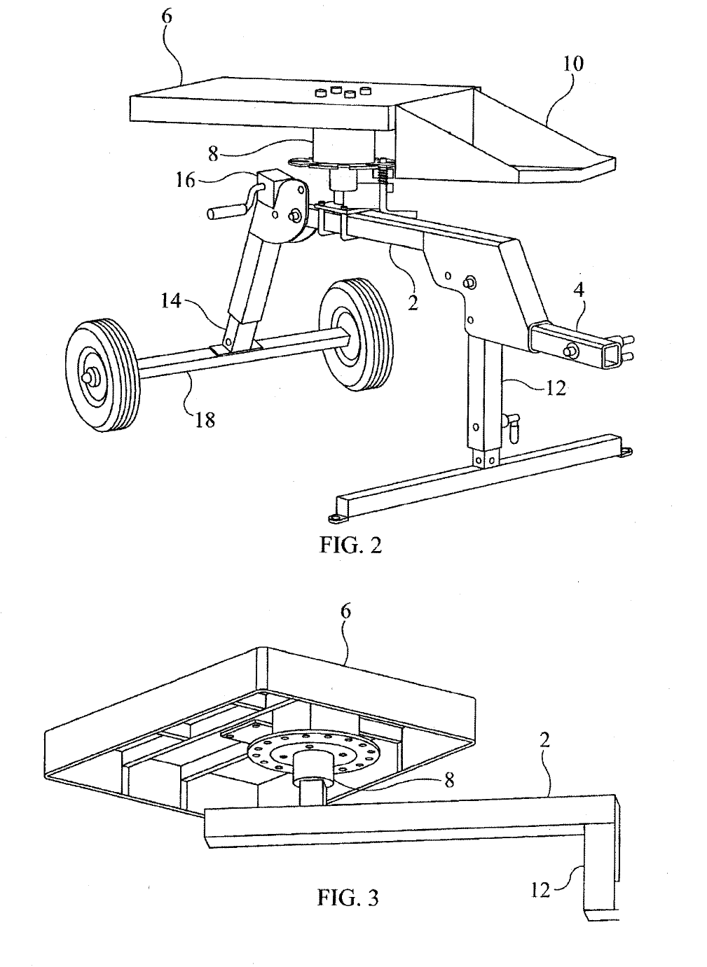

FIG. 2 is a perspective view of the embodiment of the invention shown in FIG. 1, with a second platform attached to the first platform;

FIG. 3 is a lower perspective view of the first platform, rotating hub and spindle, and main support beam;

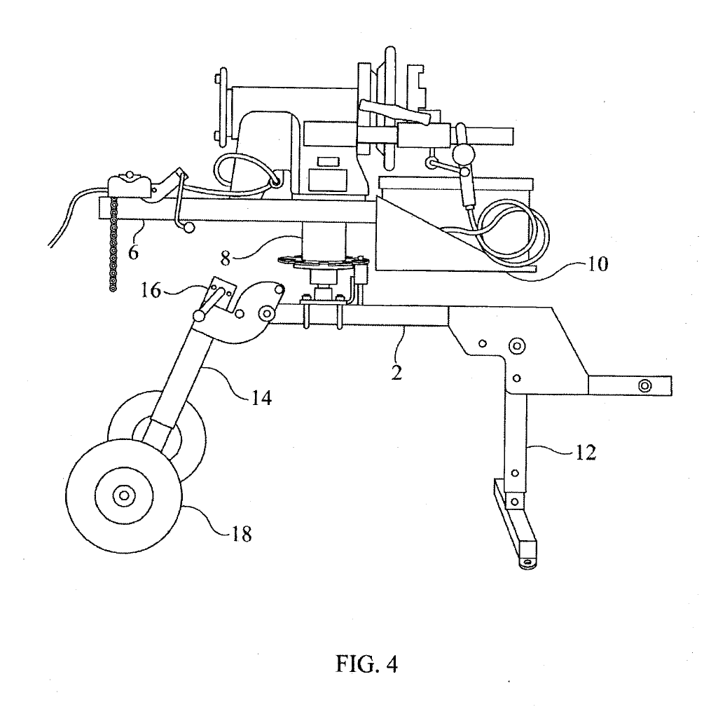

FIG. 4 is a side view of the equipment stand of the invention with a pipe and bolt threader installed on the first platform, and an oiler on the second platform, with the platforms parallel to the main support beam;

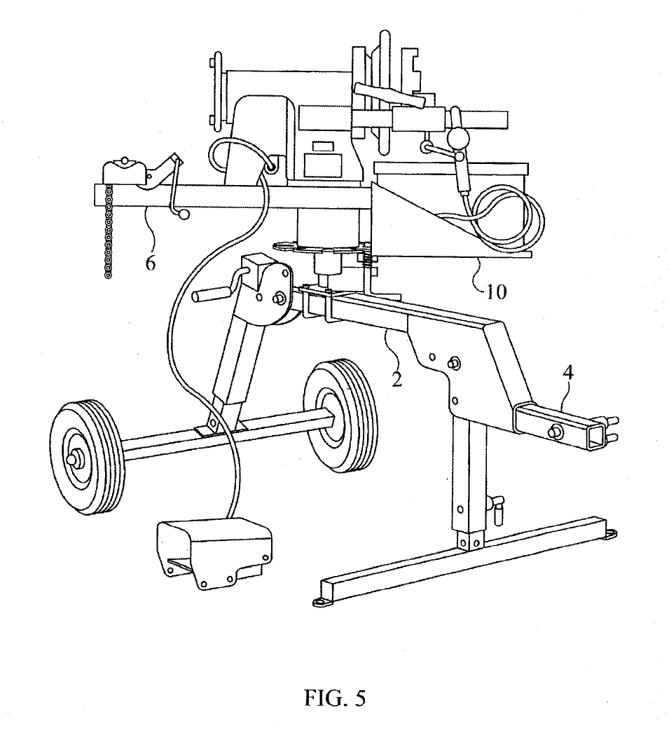

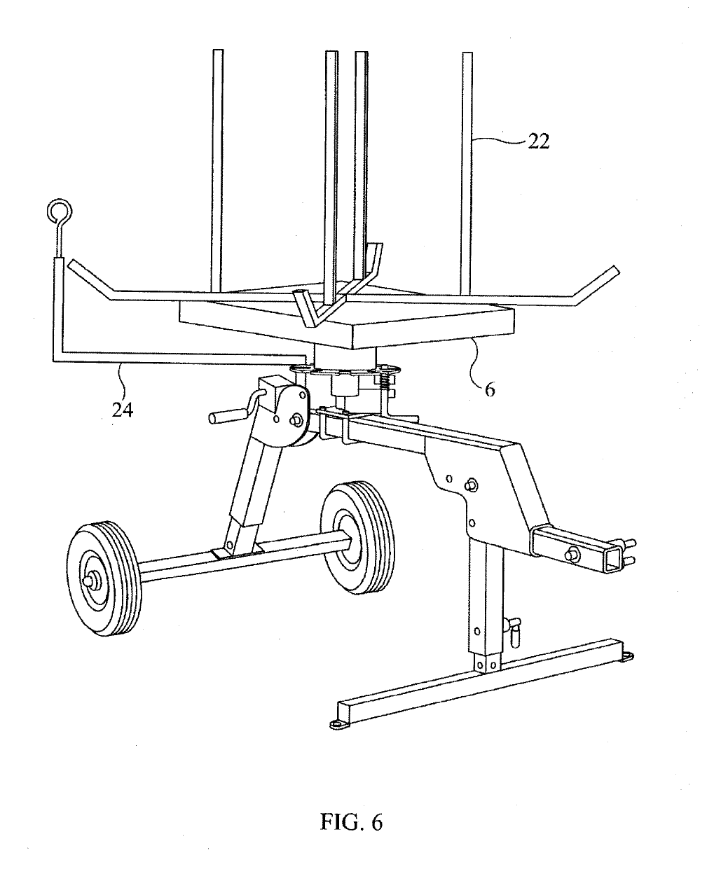

FIG. 5 is a perspective view of the equipment stand of the invention with a pipe and bolt threader installed on the first platform, and an oiler on the second platform, with the platforms non-parallel to the main support beam;

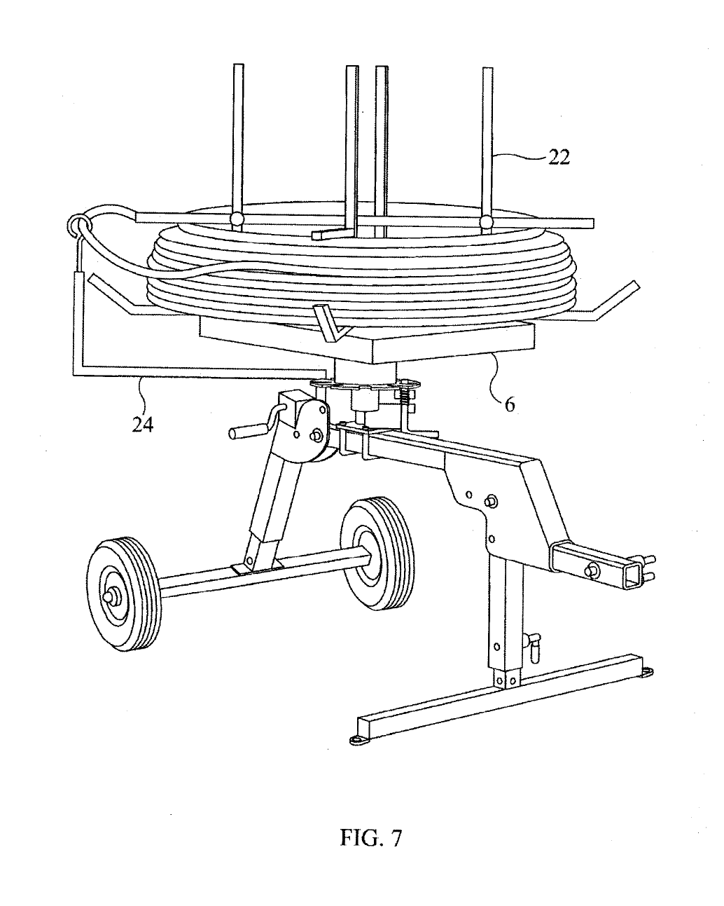

FIG. 6 is a perspective view of an alternate embodiment of the equipment stand of the invention with a coiling frame attached to the first platform and a coiling guide attached to the main support beam;

FIG. 7 is a perspective view of the alternate of the invention shown in FIG. 6, with electrical wire passing through the coil guide and wrapped around the coiling frame;

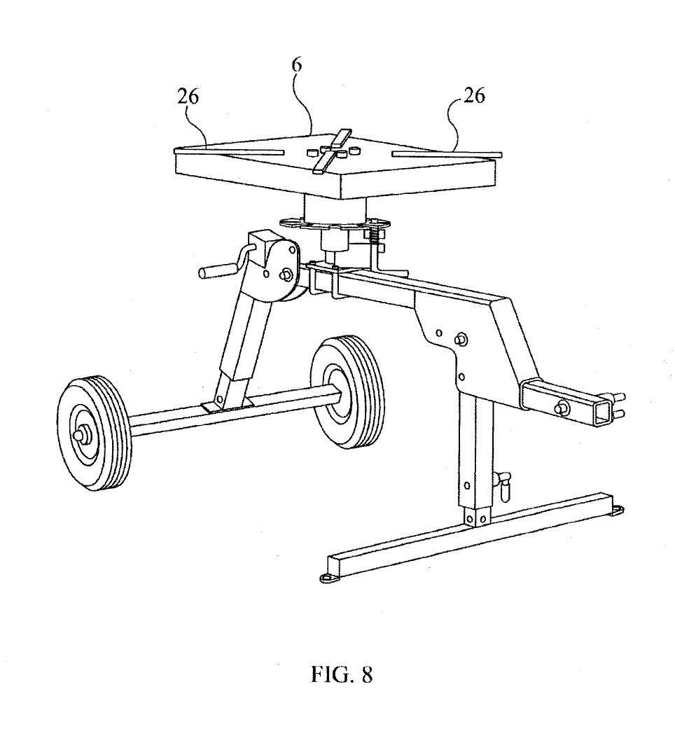

FIG. 8 is a perspective view of a further alternate embodiment of the equipment stand of the invention with generator frame brackets attached to the first platform;

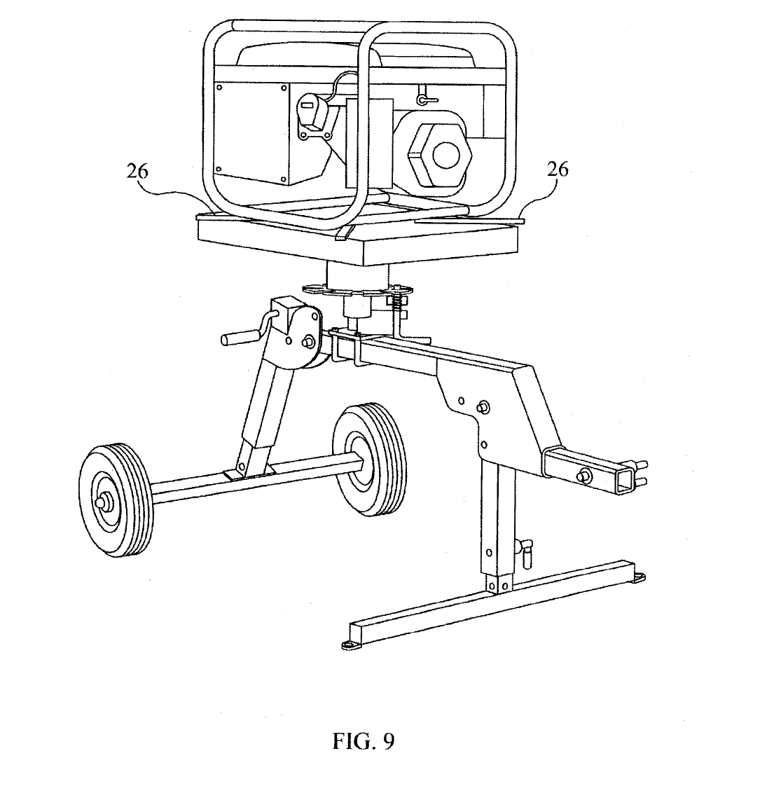

FIG. 9 is a perspective view of the embodiment of the invention shown in FIG. 8 with a generator attached to the generator frame brackets on the first platform;

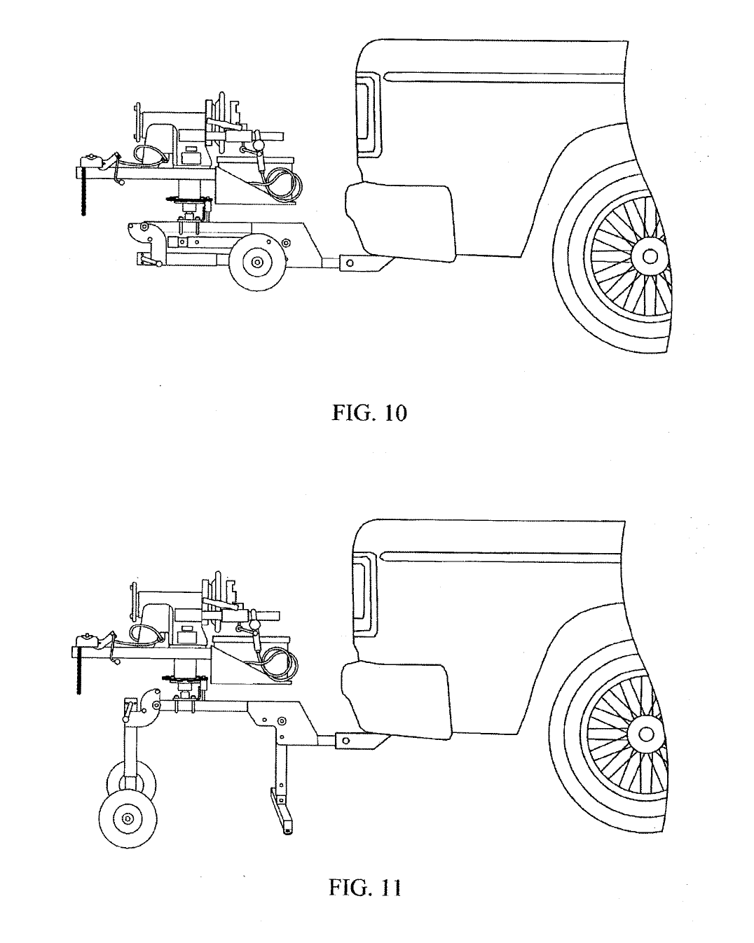

FIG. 10 shows the embodiment of the invention shown in FIG. 4 attached to the hitch of a vehicle with the wheel and axle assembly in a raised position;

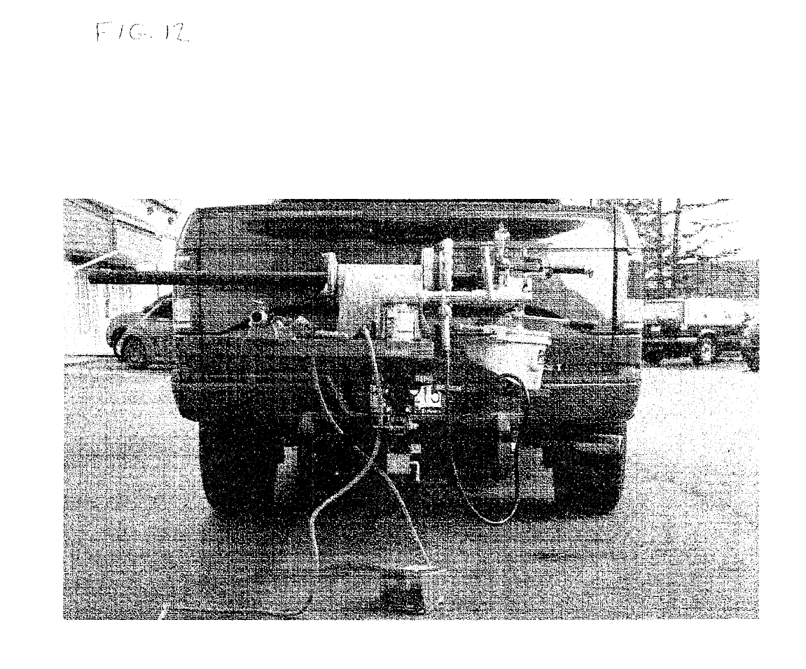

FIG. 11 shows the embodiment of the invention shown in FIG. 4 attached to the hitch of a vehicle with the wheel and axle assembly in a lowered position and the platforms positioned parallel to the main support beam;

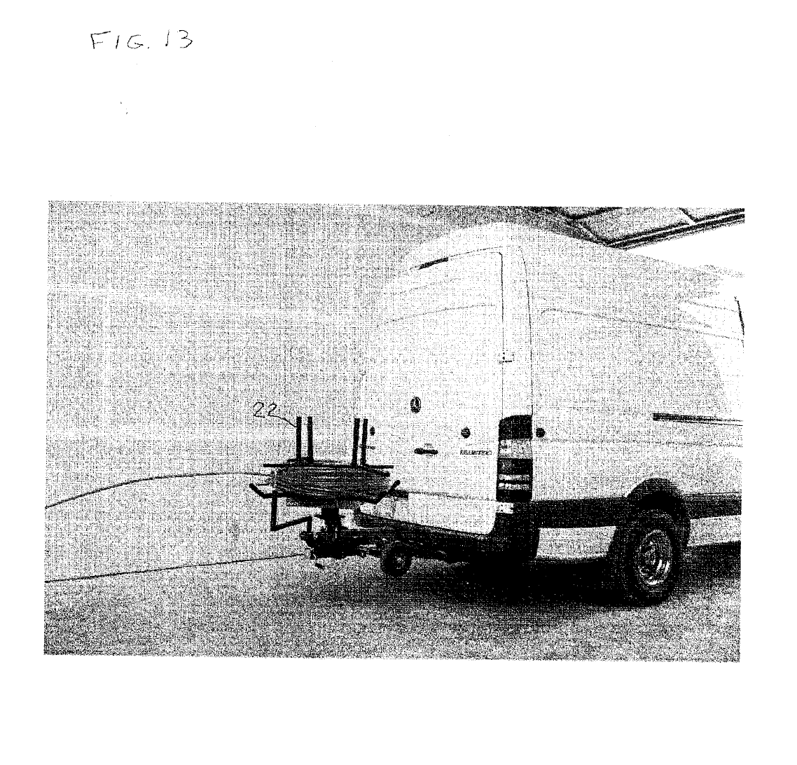

FIG. 12 shows the embodiment of the invention shown in FIG. 4 attached to the hitch of a vehicle with the wheel and axle assembly in a raised position and the platforms positioned perpendicular to the main support beam; and

FIG. 13 shows the embodiment of the invention shown in FIG. 7 attached to the hitch of a vehicle with the wheel and axle assembly in a raised position.

In the images, one embodiment of the invention is illustrated by way of example. It is to be expressly understood that the description and images are only for the purpose of illustration and as an aid to understanding, and are not intended as a definition of the limits of the invention.

### DESCRIPTION OF THE INVENTION

There is provided a vehicle hitch-mountable rigid stand for supporting construction equipment during use or transport. The device can be used while attached to the hitch of a vehicle, or can be disconnected and relocated using a set of built-in wheels and support leg.

As may be seen in the figures, in a preferred embodiment, the device of the invention consists of, but is not limited to, 7 main components which may be provided as a kit for assembly. The 7 main components are a main support beam 2 attachable to a vehicle hitch by a vehicle hitch connection post 4 at the first end, a first platform 6 connected above the main support beam by a rotating hub and spindle assembly 8, an optional second platform 10 which doubles as a first platform extension, an adjustable support leg 12 attached in proximity to the first hitch end of the main support beam, telescopic tubing 14 connecting lifting means 16 to the second end of the main support beam, and a wheel and axle assembly 18 attached to the lifting means. The lifting means may be an adjustable jack such as, for example, an hydraulic jack.

In an alternate embodiment, the wheel assembly may be connected by an axle linkage to the main support beam.

In one embodiment, the main support beam is a hollow metal tube. Means for attaching the support leg are provided near the first end and may comprise a cylinder, bolting means, or clamping means. The support leg may be attached to the main support beam by telescoping tubing. The rear telescopic tubing is provided with a hollow cylinder for receiving the wheel and axle assembly, which may be fixed in a desired vertical position, although other attachment means such as a clamp are also possible. In one embodiment, the desired vertical position of the wheel and axle assembly is achieved through adjustment of the telescopic tubing using the lifting means, allowing the stand to be used with a wide range of vehicle hitch elevations. The use of lifting means such as an adjustable jack also eliminates the need for a user to manually lift the stand into the vehicle hitch, as the adjustable jack may be used to raise the main support beam to the desired elevation for engagement with the vehicle hitch. The rear lifting means and telescopic front leg support are adjustable to select the height of the stand while attached to or independent of a vehicle.

In one alternate embodiment shown in FIGS. 6 and 7, the stand may be equipped with a coiling frame 22 and coiling guide 24. In a further embodiment shown in FIGS. 8 and 9, the stand may be equipped with generator frame brackets 26 attached to the first platform.

The wheel and axle assembly preferably comprises a pair of wheels joined by an axle having a central vertical post for attachment to the telescopic tubing or axle linkage. In one embodiment, the wheel and axle assembly may be rotated within the axle linkage to permit alignment of the axle with the main beam when not in use. In a preferred embodiment, the wheel assembly may be pivoted and stowed under the main support beam towards the front hitch end of the main support beam when not in use.

In the preferred embodiment, a rotating hub and spindle assembly connects the first platform to a medial position along the main support beam. In an alternate embodiment, a vertical platform post extends upwardly from a medial position along the main support beam, and a first platform is attached to the top of the platform post. The platform may have dimensions sufficient to support a variety of industry standard construction trades equipment. In a preferred embodiment, 360-degree rotation of the platform is achieved using a rotating hub and spindle which is lockable in numerous positions using a spring bolt latch, according to the user's needs. In an alternate embodiment, the platform may be rotated 360 degrees and locked into the desired location by means of locking pins and/or locking bolts.

The smooth action of the rotating hub and spindle permits efficient, easy use of the stand as a pipe decoiler or electrical wire decoiler whether the stand is attached to a vehicle or being used remotely.

Optionally, a second platform is attachable to the first platform and swivels with rotation of the first platform to maintain the second platform in consistent alignment relative to the equipment on the first platform. The second platform may be an oiler platform.

A support leg may be provided in proximity to the first end of the main beam to provide support to the stand when it is used apart from a vehicle hitch. The support leg may incorporate adjustment means such as telescopic tubing to permit vertical adjustment to stabilize the stand on the ground, as well as rotational adjustment to align the leg with the main support beam when not in use while the stand is attached to the hitch of a vehicle.

In one embodiment, the main support beam and the platform post may be telescopic tubing to allow for selective positioning of the distance of the wheels from the first end of the main beam, and of the height of the platform, respectively. The main beam preferably will be adjustable between approximately 36 and 50 inches, and the platform post preferably will be adjustable between 12 and 18 inches.

In an alternate embodiment, the stand may be provided with two or more wheel and axle assemblies comprising two or more pairs of wheels, rather than a wheel and axle assembly and a support leg. The wheel and axle assemblies may pivot, fold or drop down to the ground to permit the stand to be rolled away from or back to the vehicle hitch.

According to another alternate embodiment, the platform of the device may be positioned directly on and swivel about the main support beam, or a set of support beams. According to yet another embodiment, the device of the invention may include sliders attachable to the vehicle such that the stand may be slid on the sliders away from the vehicle prior to use.

In an alternate embodiment, umbrella mounting means may be provided on the stand. The stand may also be equipped with means for electrical cord storage such as tabs for wrapping cords, and may be equipped with 12 V wiring to permit illumination of a driving light.

The stand of the invention may have a handle which is used to assist in moving the apparatus when disconnected from the vehicle. The handle may be inserted into the main beam and may be locked in place using the hitch pin.

The device of the present invention may be easily set up or taken down and relocated by a single person, in contrast with existing prior art equipment which requires a minimum of two. One of the advantages of the present invention is the maintenance of access to the tailgate of a truck or the door of a van while the stand is attached to the hitch.

A variety of materials may be used in the manufacture of the stand of the present invention, provided such materials are of sufficient strength to support equipment which may weigh more than 300 lbs.

In the preferred embodiment, a vehicle hitch connection post extends perpendicularly from the support leg to permit attachment of the stand to a vehicle hitch. The wheel attachment assembly preferably is adjustable to permit raising of the wheels away from the ground or other support surface. In one embodiment, the wheel attachment assembly may allow rotation of the axle into alignment with the main support beam during transportation of the stand.

While the present invention is intended primarily for use with construction equipment, unlimited other applications for this device are also possible.

The equipment stand of the present invention may include one or more accessories, including a fitting bin, and sets of mounting brackets to accommodate the mounting pattern of a decoiler, generator, or various other equipment.

According to an alternate embodiment for use with a pipe threader, the main platform may be provided with an insertion point for the attachment of another platform for use with a pipe vise which could be used while the threader is in use.

As many possible embodiments may be made of the invention, it is to be understood that all matter described in this specification or shown in the images is illustrative and not limiting. It will be appreciated by those skilled in the art that other variations of the preferred embodiment may also be practised without departing from the scope of the invention.

1. An equipment stand comprising:
a. a main support beam having opposing first and second ends;
b. a rotating hub and spindle assembly having upper and lower ends, the assembly attachable at its lower end to the main support beam;
c. a first platform mounted to the upper end of the rotating hub and spindle assembly;
d. a support leg attached perpendicularly to the first end of the main support beam;
e. a vehicle hitch connection post extending perpendicularly from the support leg and colinearly with the main support beam;
f. lifting means hingedly connected to the second end of the main support beam;
g. telescopic tubing connecting the lifting means to a wheel and axle assembly.

2. The equipment stand of claim 1, wherein the horizontal position of the rotating hub and spindle assembly is adjustable along the length of the main support beam.

3. The equipment stand of claim 1, wherein the length of the telescopic tubing may be adjusted incrementally.

4. The equipment stand of claim 1, wherein the length of the support leg is adjustable.

5. The equipment stand of claim 1, wherein the first platform is fully rotatable about the axis of the rotating hub and spindle assembly.

6. The equipment stand of claim 1, further comprising a second platform reversibly connected along one edge of the first platform.

7. The equipment stand of claim 1, further comprising a rotatable coiling frame attached to the upper surface of the first platform and a coiling guide attached to the main support beam.

8. The equipment stand of claim 1, further comprising a plurality of generator frame brackets attached to the upper surface of the first platform.

9. The equipment stand of claim 1, wherein the wheel and axle assembly may be rotated between a raised position wherein the wheels are above the support surface in proximity to the main support beam, and a lowered position wherein the wheels are in contact with the support surface.

10. A portable equipment stand assembly comprising the equipment stand of claim 1 attached by a vehicle hitch to a vehicle.

11. A portable equipment stand assembly comprising the equipment stand of claim 7 attached by a vehicle hitch to a vehicle.

12. A portable equipment stand assembly comprising the equipment stand of claim 8 attached by a vehicle hitch to a vehicle.

13. An equipment stand kit comprising:
a. a main support beam having first and second ends;
b. a rotating hub and spindle assembly attachable at its lower end to the main support beam;
c. a first platform mountable to the upper end of the rotating hub and spindle assembly;
d. a support leg attachable perpendicularly to the first end of the main support beam;
e. a vehicle hitch connection post extendable perpendicularly from the support leg and colinearly with the main support beam;
f. lifting means hingedly connectable to the second end of the main support beam; and
g. telescopic tubing connectable between the lifting means and a wheel and axle assembly.

14. The equipment stand kit of claim 13, further comprising a rotatable coiling frame attachable to the upper surface of the first platform and a coiling guide attachable to the main support beam.

15. The equipment stand kit of claim 13, further comprising a plurality of generator frame brackets attachable to the upper surface of the first platform.
